(19) United States
(12) Patent Application Publication
(10) Pub. No.: US 2006/0065723 A1
(43) Pub. Date: Mar. 30, 2006

(54) Consumer information kiosk

(75) Inventor: Robert D. Palmquist, Faribault, MN (US)

Correspondence Address: SHUMAKER & SIEFFERT, P. A., 8425 SEASONS PARKWAY, SUITE 105, ST. PAUL, MN, 55125, US

(73) Assignee: Speechgear, Inc., Northfield, MN (US)

(21) Appl. No.: 11/221,402

(22) Filed: Sep. 7, 2005

Related U.S. Application Data
(60) Provisional application No. 60/608,236, filed on Sep. 8, 2004.

(51) Int. Cl. G06K 15/00

(52) U.S. Cl. 235/383

(57) ABSTRACT

The invention is directed to a kiosk for a retail establishment or other similar environment where customers may seek information. The customer can input a product identification or product description to the kiosk, e.g., by speaking to the kiosk or typing the product identification or description at the kiosk. The kiosk parses the user's input to identify a store location associated with the product. The kiosk outputs the location to the user, e.g., in the form of verbal or printed directions to a location of the product, or a printed map of the store with a conspicuous identification of the location associated with the product. The user can use the output of the kiosk to quickly locate the product of interest. In other embodiments, the kiosk may receive verbal requests from a user and respond accordingly.

This application claims the benefit of U.S. Provisional Application Ser. No. 60/608,236, filed Sep. 8, 2004, the entire content of which is incorporated herein by reference.

### STATEMENT REGARDING FEDERALLY SPONSORED RESEARCH FOR DEVELOPMENT

This invention was made with Government support under Contract N00014-02-C-0122 awarded by Office of Naval Research. The Government may have certain rights in this invention.

### TECHNICAL FIELD

The invention relates to computerized kiosks.

### BACKGROUND

Large retail establishments often include a wide variety of products and services, which are offered for sale to customers. Navigation through retail establishments in order to locate a desired product or service, however, can become frustrating to customers. Store workers can mitigate the frustration by aiding customers in locating the desired products or services. However, store workers are not always available to the customers, and the number of available workers is generally proportional to operational costs of the retail establishment.

Language barriers can compound problems in retail establishments. For example, if the customer and worker do not speak the same language, communication can be difficult or impossible. Ultimately, if the customer is unable to quickly locate the desired products or services within the retail establishment in a reasonable time frame, the retail establishment can lose the customer's business.

### SUMMARY

In general, the invention is directed to a kiosk for a retail establishment or other similar environment where customers may seek information about products or services. The kiosk may be multi-lingual, allowing customers to interact with the kiosk using any of a plurality of different languages. The customer can input a product identification or product description to the kiosk, e.g., by speaking to the kiosk or typing the product identification or description at the kiosk. The kiosk parses the user's input to identify a store location associated with the product. The kiosk outputs the location to the user, e.g., in the form of verbal or printed directions to a location of the product, or a printed map of the store with a conspicuous identification of the location associated with the product. The user can use the output of the kiosk to quickly locate the product of interest. In other embodiments, the kiosk may receive verbal requests from a user and respond accordingly.

In one embodiment, the invention is directed to a method comprising capturing input from a user at a kiosk, the input being indicative of a product, and identifying a location within a store, the location being associated with the product. The method also comprises outputting to the user from the kiosk an indication of the location.

In another embodiment, the invention provides a kiosk comprising an input device to capture input from a user at a kiosk, the input being indicative of a product, and a processor to identify a location within a store associated with the product. The kiosk also comprises an output device to output to the user an indication of the location.

In another embodiment, the invention provides a method comprising receiving a query in the form of voice input from a user at a kiosk, capturing the voice input, parsing the voice input to determine the meaning of the query, retrieving information as a function of the meaning of the query, and presenting the information to the user at the kiosk.

In various other embodiments, the kiosk may be implemented in malls, hospitals, medial clinics, airports, stadiums, theaters, train stations, bus terminals, schools or office buildings. Other embodiments are also described in which the kiosk collects information and possibly interacts with customers, e.g., allowing the customer to communicate with high-level voice interaction. In still other examples, the invention contemplates a store-like arrangement in which the customer places orders at a kiosk and the order is delivered to the customer, e.g., at the same store. In that case, the store may include a warehouse to house the various products, and a set of kiosks to facilitate the collection of customers orders.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a flow diagram illustrating a process in which a user interacts with a kiosk according to an embodiment of the invention.

FIG. 2 is another flow diagram illustrating a process in which a user interacts with a kiosk according to an embodiment of the invention.

FIGS. 3 and 4 are block diagrams of kiosks according to embodiments of the invention.

FIGS. 5 and 6 are block diagrams of systems in which on or more kiosks are networked to another computer according to embodiments of the invention.

### DETAILED DESCRIPTION

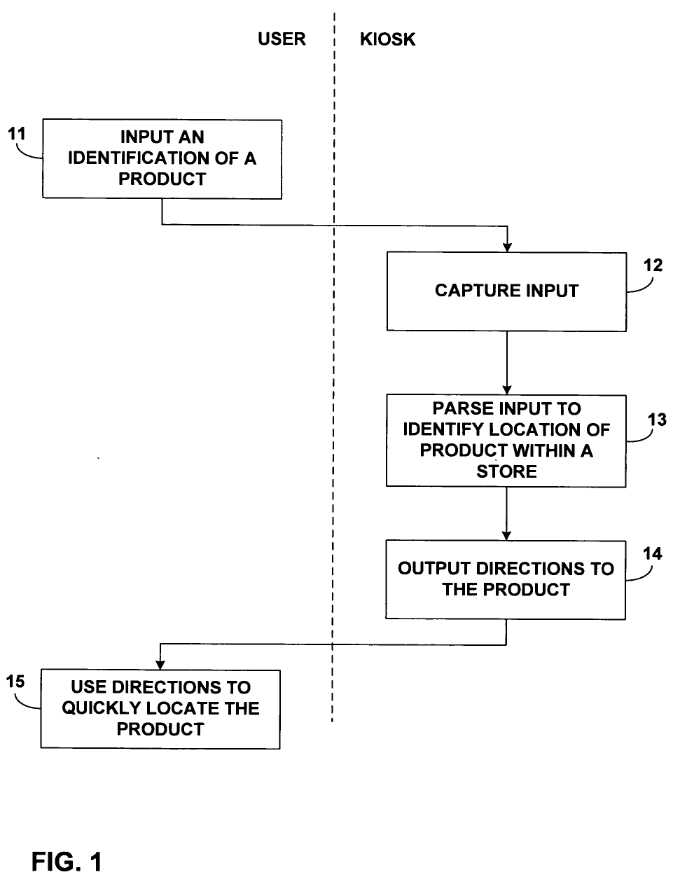

FIG. 1 is a flow diagram illustrating a process in which a user (such as a customer of a retail establishment) interacts with a kiosk. The invention, however, may also find application in a wide variety of other settings. As shown in FIG. 1, the user inputs a query to the kiosk. For purposes of illustration, the query pertains to a particular product. In this illustration, the user inputs an identification of a product to the kiosk (11). For example, the user may speak into a microphone at the kiosk to identify the product or provide a description of the product. Alternatively, the user may type the identification or description into a keypad or touch screen disposed on the kiosk. The kiosk is configured to receive the input in plain language, so that a user may input a query such as “Where are the hammers?” The kiosk may be multi-lingual, allowing the user to interact with the kiosk using any of a plurality of different languages.

The kiosk captures the input (12), and parses the input to identify a location of the product described or identified by the user (13). In particular, the kiosk identifies the product of interest to the consumer, accesses one or more databases or lookup tables that map products to locations within the establishment, and retrieves the location of the product of interest. The kiosk outputs to the user store directions to the product described or identified by the user (14). For example, the kiosk may output verbal or printed directions to a location of the product, or a printed map of the store with a conspicuous identification of the location associated with the product. The user can use the directions to quickly locate the product of interest (15).

By way of example, the kiosk may be used in a hardware store. A user may enter the hardware store and ask the kiosk: “Where are the hammers?” In response, the kiosk prints a map of the store with a marking that identifies the location of the hammers within the hardware store.

If the product identified by the user is unavailable or unknown to the kiosk, the kiosk may output an indication to the user that the desired product cannot be located. In that case, the kiosk may provide a list of related products, which the user can select to obtain directions within the store and/or provide an interface for ordering the item. For example, in response to a query about a particular brand of tool, the kiosk may inform the user that the store does not carry that brand, but may direct the user to comparable tools of other brands or allow the user to order the brand not currently in stock.

Also, if the product identified by the user is too general, the kiosk may output an indication to the user that more information is needed. In that case, the kiosk may also provide a list of products that may correspond to the product desired by the user, which the user can select to obtain directions within the store. For example, in response to a query, “Where is the paint?” the kiosk may ask the user to specify whether he is interested in interior house paint, exterior house paint, spray paint or artistic supplies.

Price information and the number of available items in stock may also be provided to the user. Also, if desired, the product information may be used to generate customer-specific advertising in real time, e.g., by printing coupons or sale literature based on the customer's request.

In other embodiments, the kiosk may respond to other queries from the customer. For example, the kiosk may be programmed to provide sale information in response to the verbal inquiry asking: “What is on sale?” In some cases, the kiosk may print coupons in response to an inquiry about sale items or an inquiry requesting the coupons. Also, the kiosk may identify customers by name or number, and operate in a “frequent customer” mode in which specific coupons or specials are presented to customers that shop or spend over a threshold. The kiosk may be useful any many environments, including retail establishments, rental stores or establishments, or any establishment where a user might query about products or services. As other examples, the kiosk may be implemented in malls, hospitals, medial clinics, airports, stadiums, theaters, train stations, bus terminals, schools or office buildings.

The kiosk may be a stand alone unit, or may be networked to central computer which maintains databases of information presented at the kiosk. In the latter case, the central computer may store inventory information, price information, and store locations associated with each product. As inventory, price or locations of a product change, these changes may be reflected in the central computer in real time, allowing the customers to obtain up-to-date information from the kiosk. For example, the central computer may also be networked to point-of-sale terminals or shipping terminals so that changes in inventory can be reflected in real time. In some cases, some information may be stored locally at the kiosk and other information may be stored on a remote computer networked to the kiosk. For example, product pricing information may be stored on a central server associated with a retail chain. However, store locations associated with each product may be stored locally on kiosks of the different establishments, as the products may be located in different locations at the different establishments.

In still other examples, the invention contemplates a store-like arrangement in which the customer places orders at a kiosk and the order is delivered to the customer, e.g., at the same store. In that case, the store may include a warehouse to house the various products, and a set of kiosks to facilitate the collection of customers orders. The customers may enter orders at the kiosks, which are then delivered directly to the customer.

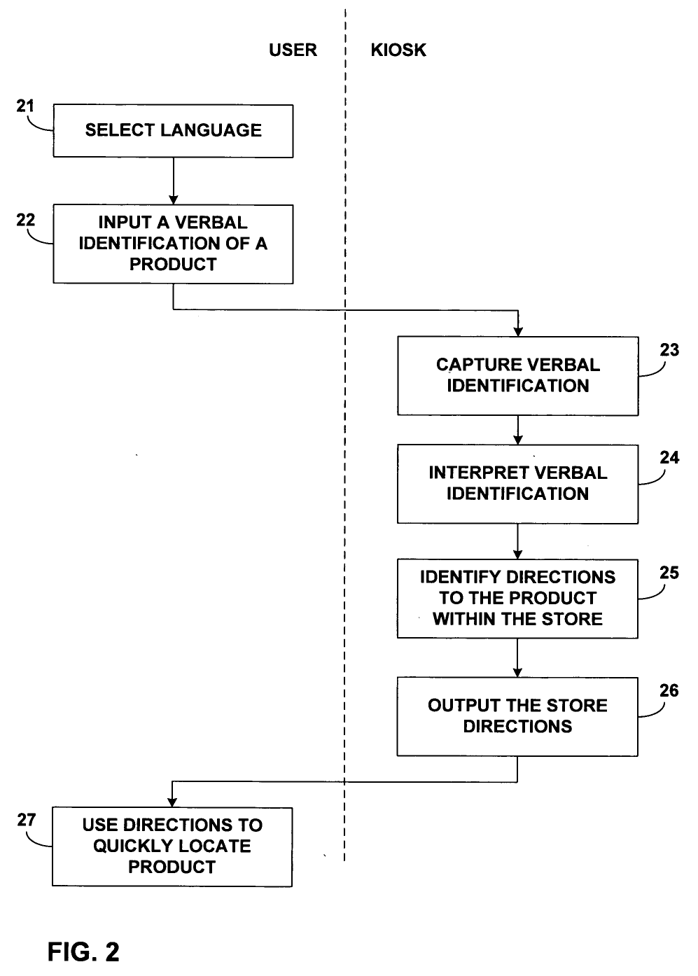

FIG. 2 a flow diagram illustrating a more detailed process in which a user interacts with a multi-lingual kiosk using verbal communication. As shown in FIG. 2, the user may select a language (21), e.g., by pressing a button or touch screen at the kiosk. For example, identifiers of different languages such as flags of different countries or a map of the world may be presented to the user for selection. The kiosk receives the selection, and interacts with the user using the language indicated by the selection. Alternatively, the kiosk may be programmed to identify a given language automatically, based on usage and context of the user's speech.

The user inputs a query, such as a verbal identification of a product (22). The kiosk captures the verbal identification (23), and performs interpretation with respect to the verbal identification (24). For example, the kiosk may execute speech recognition software in order to interpret the user's speech. Based on the interpretation of the user's verbal identification of the product, the kiosk identifies directions to the product within the store (25). The kiosk outputs these directions to the user (26), and the user utilizes the directions to quickly locate the product within the store (27). For example, the kiosk may output verbal or printed directions to a location of the product, or a printed map of the store with a conspicuous identification of the location associated with the product. In any of these cases, the user can use the directions to quickly locate the product of interest (27). If a product is unavailable or out of stock, the kiosk may also allow the customer to place an order for the product.

In a variation of the method, the kiosk may interrogate the user about his or her query. For example, if the user asks about paint, the kiosk may interrogate the user about the kind of paint that the user wants. In some cases, the speech recognition software may determine that the query is ambiguous, and may ask the user to clarify. For example, if the user asks about “mailboxes” but does not enunciate clearly, the kiosk may ask the user whether he meant to ask about “mailboxes” or “nail boxes.”

Also, the kiosk may allow for high-level voice interaction in which the customer does not identify a product, but rather a goal that the customer wants to achieve. In response, the kiosk may determine how the customer can meet that goal, and identify various products that could help meet the goal. For example, the customer may indicate that they need to cook low-salt meals for four people (the goal). In response, the kiosk may generate a variety of recipes (ways to meet the goal) and identify where the ingredients are located within the store (products that can help meet the goal).

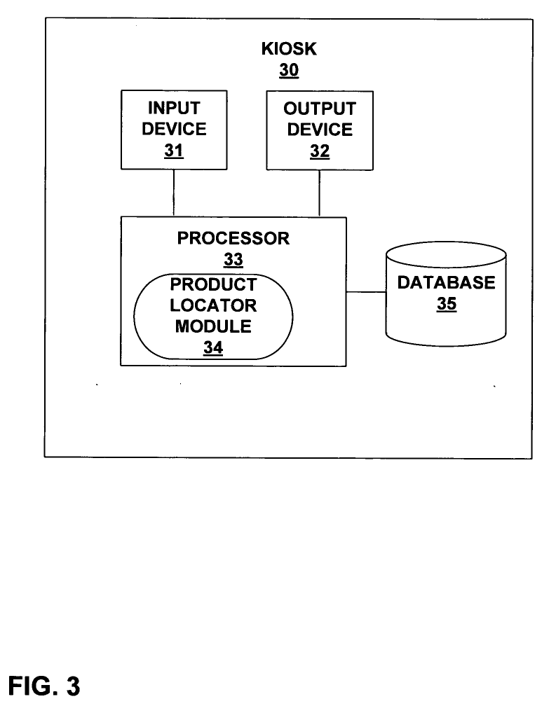

FIG. 3 is a block diagram of one embodiment of a kiosk 30 according to an embodiment of the invention. Kiosk 30 includes an input device 31 to receive input from a user and an output device to provide output to the user. Input device 31 may comprise, for example, a microphone at the kiosk through which the user speaks, or a keyboard or touch screen that the user can use to type the identification or description of a desired product.

Input device 31 captures the input from the user, and provides the input to processor 33. Processor 33 parses the input to identify the product in question and to determine a location of the product described or identified by the user. Processor 33 may comprise a general purpose microprocessor, an application specific integrated circuit (ASIC), a field programmable gate array (FPGA), or another processor. Processor 33 executes a product locator module 34, which may be implemented in hardware or software, which determines a location as a function of the product in question. Processor 33 also accesses database 35, which stores mappings between products and locations within the store.

In one implementation, processor 33 may comprise a general purpose microprocessor such as those commercially available from Intel Corporation of Santa Clara, Calif. In that case, processor 33 executes an operating system such as the Windows operating system commercially available from Microsoft Corporation, of Redmond, Wash.

Database 35 may comprise a relational database management system (RDBMS), a database management system hierarchical (HDBMS), a multidimensional database management system (MDBMS), an object-oriented database management system (ODBMS or OODBMS) or an object-relational database management system (ORDBMS). Data may be stored, for example, within a single relational database 35 such as SQL Server from Microsoft Corporation. If multiple different languages are supported, database 35 may include one or more dictionaries for each language.

Product locator module 34 may comprise a software program designed to execute on processor 33. Product locator module 34 causes processor 33 to access database 35 in order to identify mappings between products and locations within the store. Thus, when a user inputs an identification or description of a product using input device 31, processor 33 identifies the product, identifies the location of the product and outputs that location to the user via output device 36. Output device 36, for example, may comprise a display screen, an audio speaker, or a printer that prints a map of the store with a conspicuous marking to indicate the location of the product in question within the store.

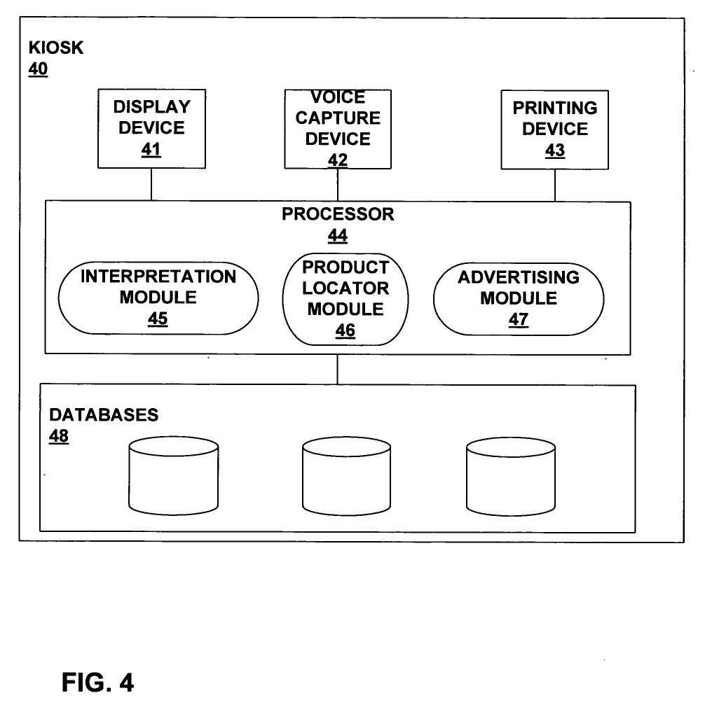

FIG. 4 is another block diagram of an embodiment of a kiosk 40 according to an embodiment of the invention. Kiosk 40 includes a display device 41, a voice capture device 42 and a printing device 43. Processor 44 is coupled to each of devices 41, 42, 43. Display device 41 provides a visual interface to the user and may comprise a touch screen. The user may select a desired language by selecting an identifier of the desired language on the touch screen. Kiosk 40 receives the user's language selection and configures itself to operate in the selected language.

Voice capture device 42 may comprise a microphone that captures the user's speech. Printing device 43 may comprise any of a wide variety of printers, including but not limited to a dot-matrix printer, a laser printer, an ink-jet printer, or another printer.

Processor 44 may comprise a general purpose microprocessor that executes software modules including an interpretation module 45, a product locator module 46 and an advertising module 47. Processor 44 can access one or more databases 48, which store the data needed to execute the techniques described herein. The modules and processor could also be implemented solely in hardware, e.g., in an ASIC.

Voice capture device 42 captures voice information from the user indicative of a product that the user is trying to locate. The voice information may identify the product by name or brand, for example, or simply describe the product. Processor 44 receives the voice information and invokes interpretation module 45 to interpret the voice information. Interpretation module 45 may comprise voice recognition software or embedded hardware. If desired, different interpretation modules may be used for different languages selected by the user. Also, databases 48 may include a plurality of dictionaries in order to allow the one or more interpretation modules to support different languages. In any case, interpretation module 45 determines from the voice information what product the user is trying to locate. In a variation of the embodiment, kiosk 40 may interrogate the user via an output device, such as display device 41, about the user's query.

Product locator module 46 comprises a software program or embedded hardware that causes processor 44 to access databases 48 in order to identify mappings between products and locations within the store. Thus, by invoking product locator module 46, processor 44 identifies the location of the product identified by interpretation module 45. Processor 44 outputs the identified location of the product to the user via display device 41, printing device 43, or both. Printing device 43, for example, may print a map of the store with a conspicuous marking to indicate the location of the product in question within the store. A template map of the store can be stored in databases 48 so that when the location is identified, processor 44 can generate a map with a conspicuous marking of the location by adding the marking to the template map of the store.

If desired, processor 45 may also execute an advertising module 47. Advertising module 47 uses information indicative of the product identified by interpretation module 45 to generate customer-specific advertising material in real time. For example, advertising module 47 may cause printing device 43 to print coupons or sale literature based on the customer's request. In particular, advertising module 47 may cause printing device 43 to print coupons or sale literature based on the product identified by interpretation module 45, or based on the location identified by product locator module 46. As the user is likely to proceed to the location of the product in question, coupons or sales literature related to other products in close proximity to the product in question may be very effective marketing tools.

The invention is not limited to the specific input or output devices described herein. In some embodiments, for example, kiosk 40 may include a speech synthesis module that presents the output information audibly by way of a speaker. Kiosk 40 can also present pre-recorded messages or announcements via the speaker. Furthermore, kiosk 40 may present output information in a variety of formats, presenting some information visually via display device 41, presenting other information in written form via printing device 43, and presenting additional information audibly via the speaker.

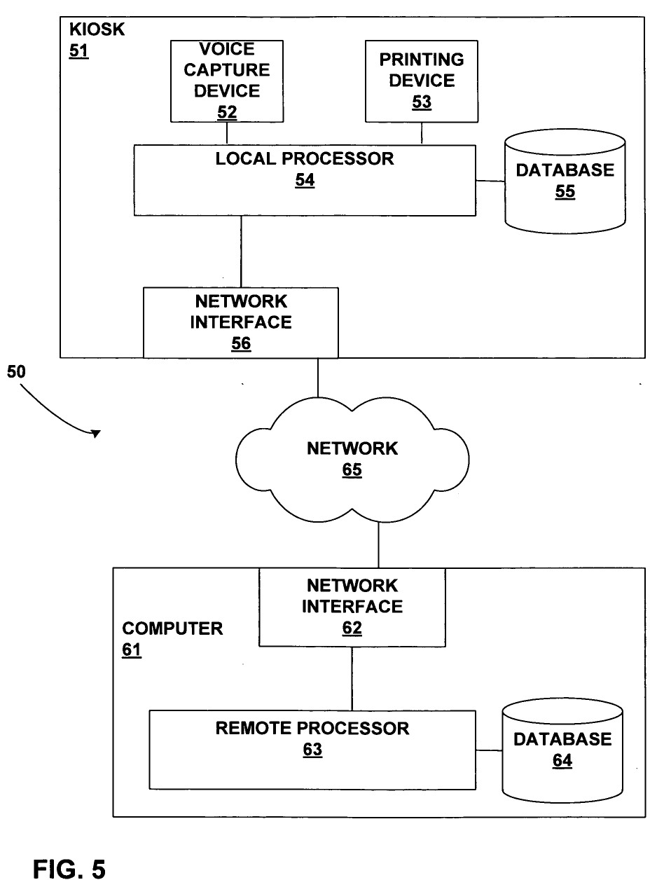

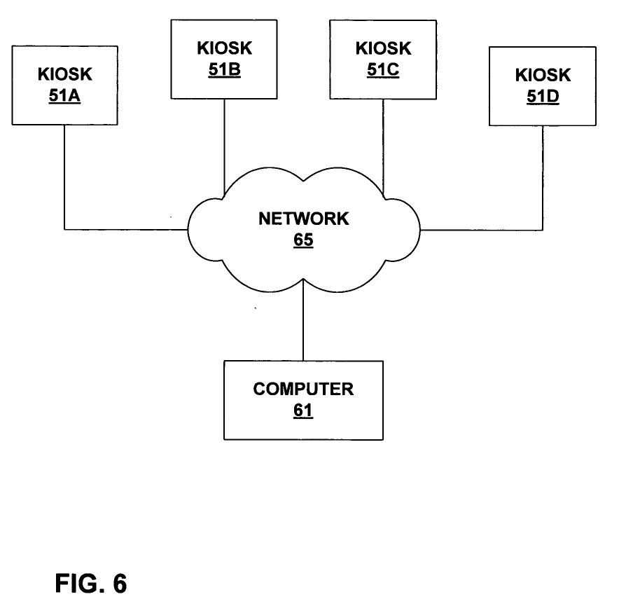

The kiosks described herein may be stand alone units, or may be networked to central computer that maintains databases of information presented at the kiosk. FIG. 5 is a block diagram of a system 50 including a kiosk 51 coupled to a computer 61 via a network 65. Network 65 may comprise a small local area network (LAN), a wide area network, or even a global network such as the Internet. Voice information may be transferred between the kiosk and other devices of the network via a voice over IP protocol, or may be translated to text locally at the kiosk prior to transmission. In any case, a communication link between kiosk 51 and computer 61 allows kiosk 51 to harness the processing capabilities and storage capabilities of computer 61. Moreover, the information stored on computer 61 may be accessible by a plurality of different kiosks 51A-51D via network 65, as shown in FIG. 6. Accordingly, updates to information on computer 61 can be reflected in real time to the output of kiosks 51A-51D.

Referring again to FIG. 5, kiosk 51 includes a voice capture device 52 and a printing device 53. Voice capture device 52 and printing device 53 are coupled to local processor 54 located locally in kiosk 51. Local processor 54 may access local database 55 in order to execute some or all of the techniques described herein.

Kiosk 51 also includes a network interface 56 which facilitates communication with computer 61 over network 65. Computer 61 likewise includes a network interface 62 to communication with kiosk 51. Computer 61 also includes a remote processor 63 (remote with respect to kiosk 51) and a remote database 64.

Remote processor 63 may access remote database 64, at the direction of kiosk 51 in order to execute some or all of the techniques described herein. In that case, communication between kiosk 51 and computer 61 allows kiosk 51 to harness the processing capabilities of remote processor 63. Moreover, the information stored in remote database 64 of computer 61 is accessible to kiosk 51. Accordingly, updates to information on computer 61 can be reflected in real time to the output of kiosk 51, as well as other kiosks 51A-51D (FIG. 6). In some cases some information can be stored in remote database 64, e.g., information that is common for a set of establishments, and other information can be stored locally in local database 55, e.g., information that may vary across the set of establishments.

Remote database 64 of computer 61 may store inventory information, price information, and store locations associated with each product. As inventory, price or locations of a product change, these changes may be reflected in the central computer in real time, allowing the customers to obtain up-to-date information from any given kiosk 51A-51D. Accordingly, the need to update information at the individual kiosks can be avoided. Also, computer 61 may be networked to point-of-sale terminals or shipping terminals so that changes in inventory can be reflected in real time. These point-of-sale terminals or shipping terminals, for example, may be included within network 65.

Various embodiments of the invention have been described. In accordance with the invention, the techniques and embodiments described herein may be implemented in hardware, software, firmware, or any combination thereof. If implemented in software, the techniques may be directed to a computer-readable medium in a kiosk, comprising program code that when executed in the kiosk performs one or more of the techniques described herein. The kiosk may include, for example, one or more processors which access the instructions stored on the computer-readable medium, and execute the instructions in order to perform one or more the techniques described herein.

Nevertheless, various modifications may be made to the embodiments described above. For example, although primarily described in the context of a retail establishment, the invention may also be useful in a wide variety of other settings, including but not limited to medial clinics, airports, stadiums, theaters, train stations, bus terminals, schools or office buildings. Other embodiments contemplate a kiosk collects information such as customer shopping trends and possibly interacts with customers based on the collected information. In that case, for example, the kiosk may support a “frequent customer” mode that prompts user-specific action for frequent customers or customers that have spent over a threshold amount in the past.

The kiosk may also allow customer to communicate with high-level voice interaction, e.g., allowing the customer to state goals which prompt the kiosk to identify ways to achieve the goals and products that may help. In still other examples, the invention contemplates a store-like arrangement in which the customer places orders at a kiosk and the order is delivered to the customer, e.g., at the same store. In that case, the store may include a warehouse to house the various products, and a set of kiosks to facilitate the collection of customers orders. These and other embodiments may be within the scope of the following claims.

1. A method comprising:
capturing input from a user at a kiosk, the input being indicative of a product;
identifying a location within a store, the location being associated with the product; and
outputting to the user from the kiosk an indication of the location.

2. The method of claim 1, wherein capturing input comprise capturing voice input identifying the product.

3. The method of claim 1, wherein capturing input comprise capturing voice input describing the product.

4. The method of claim 1, wherein the indication of the location comprises a map of the store with a conspicuous marking that identifies the location on the map.

5. The method of claim 4, wherein outputting the indication of the location comprises printing the map of the store with the conspicuous marking.

6. The method of claim 4, wherein outputting the indication of the location comprises displaying the map of the store with the conspicuous marking.

7. The method of claim 1, further comprising outputting advertising material to the user, the advertising material being generated based on the input indicative of the product.

8. The method of claim 1, further comprising outputting advertising material to the user, the advertising material being generated based on the location.

9. The method of claim 1, further comprising outputting advertising material to the user, the advertising material including a coupon for another product located in proximity to the location.

10. The method of claim 1, further comprising receiving from the user a selection, wherein the selection defines a selected language, wherein the input is captured in the selected language and the location is outputted in the selected language.

11. A kiosk comprising:
an input device to capture input from a user at a kiosk, the input being indicative of a product;
a processor to identify a location within a store associated with the product; and
an output device to output to the user an indication of the location.

12. The kiosk of claim 11, wherein the input device comprises a microphone to capture voice input identifying the product.

13. The kiosk of claim 11, wherein the input device comprises a microphone to capture voice input describing the product.

14. The kiosk of claim 11, wherein the indication of the location comprises a map of the store with a conspicuous marking that identifies the location on the map.

15. The kiosk of claim 14, wherein the output device comprises a printing device to print the map with the conspicuous marking.

16. The kiosk of claim 14, wherein the output device comprises a display device to print the map with the conspicuous marking.

17. The kiosk of claim 11, further comprising outputting advertising material to the user, the advertising material being generated based on the input indicative of the product.

18. The kiosk of claim 11, wherein the processor generates advertising material and the output device outputs the advertising material to the user, the advertising material being generated based on the location.

19. The kiosk of claim 11, wherein the processor generates advertising material and the output device outputs the advertising material to the user, the advertising material including a coupon for another product located in proximity to the location.

20. The kiosk of claim 11, wherein the kiosk receives a selection from the user, wherein the selection defines a selected language and wherein the input is captured in the selected language and the location is outputted in the selected language.

21. A method comprising:
receiving a query in the form of voice input from a user at a kiosk;
capturing the voice input;
parsing the voice input to determine the meaning of the query;
retrieving information as a function of the meaning of the query; and
presenting the information to the user at the kiosk.

22. The method of claim 21, further comprising:
interrogating the user about the query;
receiving the response of the user to the interrogation; and
retrieving information as a function of the response.

23. The method of claim 21, wherein the query comprises an indication of a product and wherein the presented information comprises a location associated with the product.
